(19) United States
(12) Patent Application Publication
(10) Pub. No.: US 2015/0242638 A1
(43) Pub. Date: Aug. 27, 2015

(54) PRIVACY CONTROL FOR MULTIMEDIA CONTENT

(71) Applicant: Microsoft Technology Licensing, LLC, Redmond, WA (US)

(72) Inventors: Hadas Bitran, Ramat Hasharon (IL); Dikla Dotan-Cohen, Netanya (IL); Shahar Yekutiel, Tel Aviv (IL); Oded Vainas, Petach Tikva (IL); Elinor Axelrod, Hod-Hasharon (IL)

(21) Appl. No.: 14/186,618

(22) Filed: Feb. 21, 2014

(51) Int. Cl. G06F 21/60

(52) U.S. Cl. CPC G06F 21/60

(57) ABSTRACT

One or more techniques and/or systems are provided for providing and/or applying privacy preferences for an entity. A multimedia device, such as a mobile phone, may capture multimedia content associated with an entity (e.g., a photo of a person at a restaurant). The multimedia device may identify a privacy preference for the entity. In an example, the person may be wearing a privacy object that may be recognized as corresponding to the privacy preference. In another example, a device associated with the person may emit a signal that may specify a privacy preference for the person and/or may be used by the multimedia device to identify the person (e.g., the identity may be used to query a service to obtain a privacy preference specified for the person). The privacy preference may be applied to the multimedia content (e.g., a no photography privacy preference, a no tagging privacy preference, etc.).

### BACKGROUND

Many users have devices, such as mobile phones, tablets, glasses or other wearable devices, etc., capable of capturing multimedia content. In an example, a user may capture video of a college campus while walking to class. In another example, a user may capture a photo of friends and/or other bystanders at a restaurant. In this way, various types of multimedia content, depicting entities (e.g., a person, a business, military equipment or personnel, documents, a prototype car, a monument, etc.), may be captured. Such multimedia content may be published and/or shared with other users. In an example, a user may post a video to a social network. In another example, a user may share an image through an image sharing service. Accordingly, entities, such as bystanders, may inadvertently be captured within multimedia content and then undesirably exposed through multimedia content made available to other individuals (e.g., a bystander walking across the college campus may not want photos of herself posted and/or tagged through a social network). Moreover, such tagging may occur in an automated fashion, such as where a social network utilizes automatic tagging and/or recognition algorithms, such as facial recognition algorithms. In this manner, a bystander may be recognized and/or tagged, such as being at a particular location at a particular time, where the bystander would instead prefer to remain anonymous with her whereabouts remaining undisclosed.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for providing and/or applying privacy preferences for an entity are provided herein. In an example of providing a privacy preference, a multimedia device may capture multimedia content associated with an entity. In an example, the multimedia device may have created the multimedia content (e.g., the multimedia device, such as a mobile phone, may comprise a camera used to capture a photo depicting a group of people at a baseball game). In another example, the multimedia device may have captured the multimedia content by obtaining the multimedia content from a device that created the multimedia content or from another source (e.g., the photo may have been transferred to the multimedia device, such as from a laptop, using a memory device, a download process, email, etc.).

A privacy preference provider component may be configured to receive a query from the multimedia device (e.g., the privacy preference provider component may be hosted by a server remotely accessible to the multimedia device and/or a local instantiation of the privacy preference provider component may be hosted locally on the multimedia device). The query may specify an entity identifier of the entity associated with the multimedia content. In an example, the entity identifier may correspond to John who was recognized based upon photo recognition, voice recognition, and/or other types of recognition. In another example, the entity identifier may have been identified by the multimedia device based upon a signal broadcast from a device associated with the entity (e.g., a device, such as John's mobile phone, may have broadcast an RF signal, a Bluetooth signal, or other signal comprising the entity identifier).

The privacy preference provider component may be configured to identify an entity profile matching the entity identifier (e.g., John may have setup an entity profile specifying that users may publish pictures of John, but cannot tag John and cannot log activities of John, such as through social networks). Accordingly, the privacy preference provider component may provide a privacy preference, such as a no tagging privacy preference and a no logging privacy preference, to the multimedia device. In this way, the multimedia device may apply the privacy preference to the multimedia content.

It may be appreciated that the multimedia device may be configured to identify and/or apply privacy preferences based upon a variety of information, such as a signal broadcast from a device associated with the entity (e.g., the device may broadcast a privacy preference to blur photos of the user), object recognition of a privacy object (e.g., an amulet may be identified as specifying that the user is not to be tagged and/or to blur photos of the user), a gesture recognition of a gesture (e.g., John may cross his arms indicating that video of John is not to be captured), etc.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a component block diagram illustrating an exemplary system for managing entity profiles.

FIG. 2 is a flow diagram illustrating an exemplary method of applying a privacy preference for an entity.

FIG. 3 is a component block diagram illustrating an exemplary system for providing privacy preferences for an entity based upon a privacy preference provided by a privacy preference provider component.

FIG. 4 is a component block diagram illustrating an exemplary system for providing privacy preferences for an entity based upon a privacy preference provided by a privacy preference provider component.

FIG. 5 is a component block diagram illustrating an exemplary system for providing privacy preferences for an entity based upon a signal.

FIG. 6 is a component block diagram illustrating an exemplary system for providing privacy preferences for an entity based upon a privacy object.

FIG. 7 is a component block diagram illustrating an exemplary system for providing privacy preferences for an entity based upon a gesture.

FIG. 8 is an illustration of an exemplary computer readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide an understanding of the claimed subject matter. It may be evident, however, that the claimed subject matter may be practiced without these specific details. In other instances, structures and devices are illustrated in block diagram form in order to facilitate describing the claimed subject matter.

As devices, such as cell phones, tablets, wearables and/or other devices, become increasingly connected and capable of capturing information about entities (e.g., posting a photo of a person to a social network; sharing a video of a person through a video sharing service; streaming an audio recording of a song through a website; etc.), privacy concerns arise. For example, a user may capture a photo of John at a restaurant. The user may upload the photo to a social network, tag John in the photo, and/or allow various services to track and/or profile John based upon the photo, which may go against the desires of John who may wish to not have his photo taken, shared, tagged, etc. (e.g., John may not wish to be associated with a specific location at a certain time and/or with certain individuals documented in the photo). Accordingly, as provided herein, privacy preferences for entities may be provided and/or applied to multimedia content.

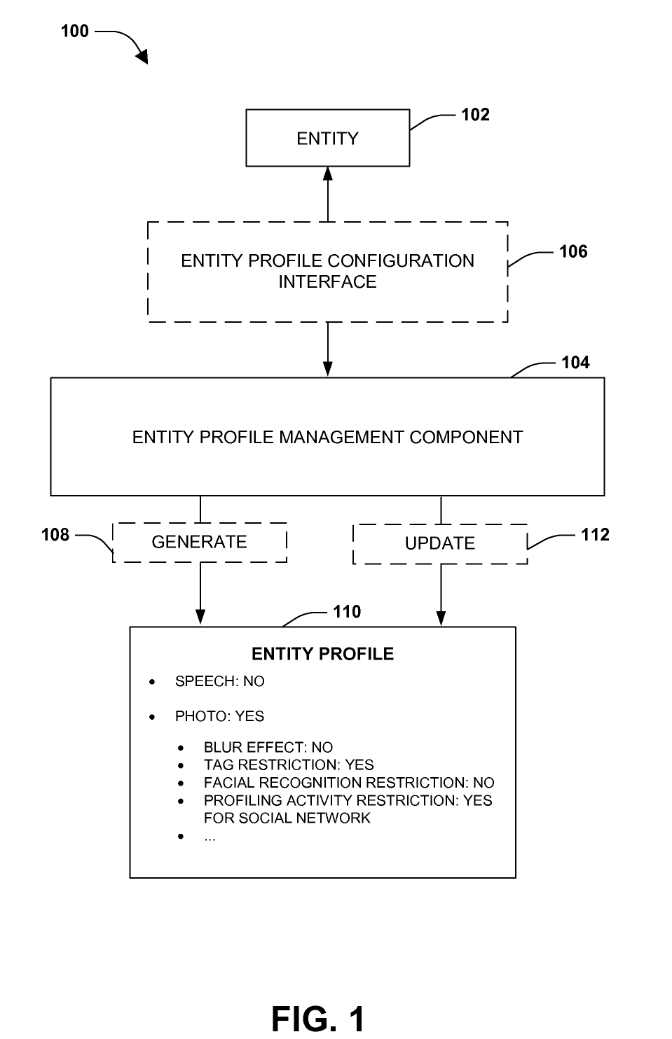

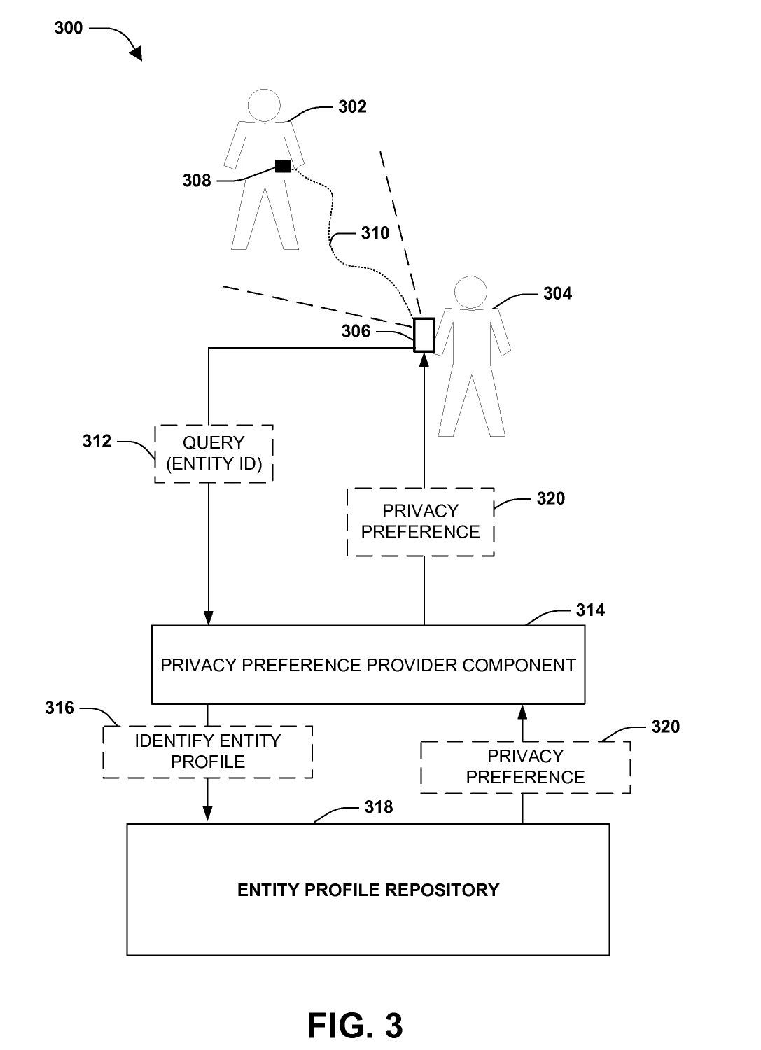

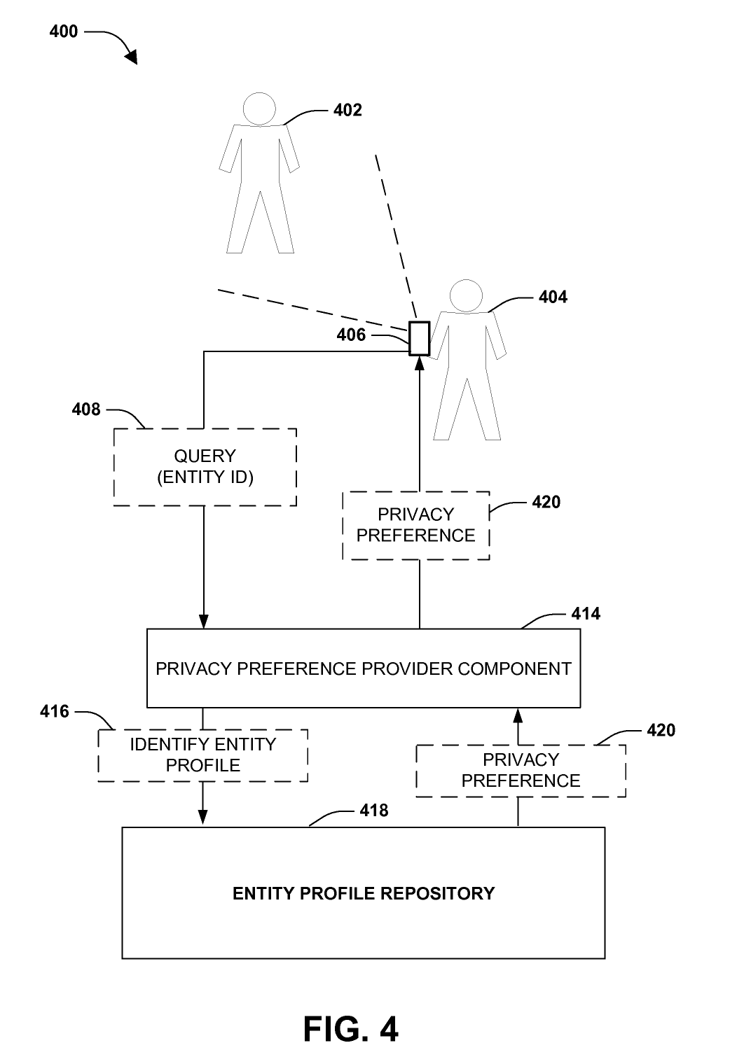

FIG. 1 illustrates an example of a system 100 for managing entity profiles. The system 100 comprises an entity profile management component 104. The entity profile management component 104 may be configured to provide an entity profile configuration interface 106 to an entity 102. In an example, the entity profile management component 104 may be hosted by a server accessible to remote devices. For example, the entity profile configuration interface 106 may be provided to a device (e.g., through an app on a tablet device; through a website accessed through a personal computer; etc.) responsive to receiving a new registration request from the entity 102. In an example, the entity profile management component 104 may receive new entity privacy preference information through the entity profile configuration interface 106. For example, the new entity privacy preference information may specify that the entity 102 has no preference for speech privacy, but has various preferences for photo privacy such as a no tagging privacy preference, a no profiling activity preference for a social network, a no location tagging privacy preference, etc. In this way, the entity profile management component 104 may generate 108 an entity profile 110 for the entity 102. In an example, the entity profile management component 104 may receive a new entity privacy preference update from the entity 102 through the entity profile configuration interface 106 (e.g., the entity 102 may now desire to blur video recordings of the entity 102). Accordingly, the entity profile management component 104 updates 112 the entity profile 110 based upon the new entity privacy preference update. In an example, the entity 102 may be restricted to updating the entity profile 110 owned by the entity 102 and/or certain aspects thereof (e.g., image restrictions but not video restrictions). In an example, the entity 102 may be authorized and/or otherwise have rights to update a profile of another entity (e.g., a parent may update an entity profile of a child or other entities for which the parent has custodian/guardian responsibilities; a manager may update an entity profile of employees; military personal may update an entity profile for military equipment; a hospital administrator may update entity profiles for hospital rooms, equipment, personal, procedures; an art gallery curator may update entity profiles for pieces of art; etc.). The entity 102 may update the entity profile 110 on an ongoing and/or dynamic basis (e.g., the entity 102 may update the entity profile 110 for the duration of a vacation or other temporal time span). In an example, the entity profile 110 may be maintained within an entity profile repository accessible to a privacy preference provider component, such as a cloud service accessible to multimedia devices (e.g., FIGS. 3 and 4). The privacy preference provider component may provide privacy preference information to the multimedia devices so that the multimedia devices may enforce privacy preferences for multimedia content.

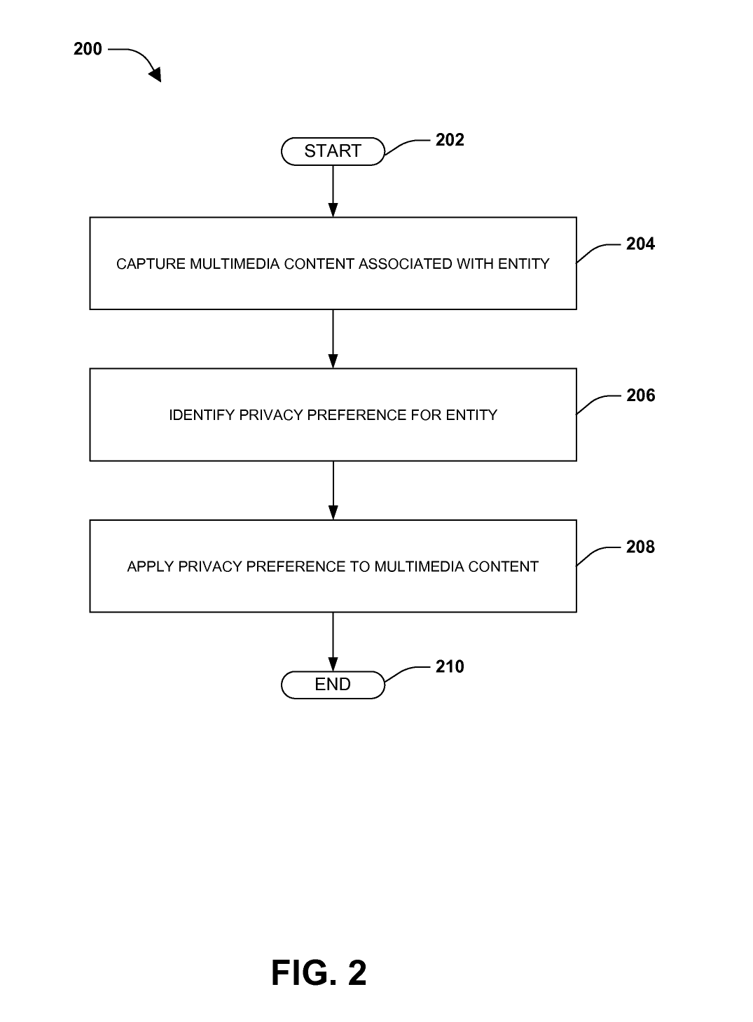

An embodiment of applying a privacy preference for an entity is illustrated by an exemplary method 200 of FIG. 2. At 202, the method starts. At 204, multimedia content associated with an entity may be captured. For example, a multimedia device may capture the multimedia content by generating the multimedia content (e.g., create a photo using a camera of the multimedia device, such as a mobile phone) and/or by receiving the multimedia content (e.g., a user may upload a photo to the multimedia device, such as a personal computer). The entity may correspond to a variety of entities, such as a person, a business, a document, an object, military personnel or equipment, a car, an art project, and/or a wide variety of other people, places, or things. In some embodiments, the multimedia device may comprise an override component that may override privacy protection. For example, police, FBI, an employer, a security surveillance camera, and/or other multimedia devices and/or entities may utilize the override component to override privacy protection so that entities are unable to circumvent detection (e.g., so that an entity cannot abuse privacy protection to commit a crime).

At 206, a privacy preference for the entity may be identified. In an example of identifying a privacy preference, a signal broadcast from a device associated with the entity may be identified (e.g., an app of a mobile phone may cause the phone to broadcast an RF signal, a Bluetooth signal, or other type of signal; a privacy device, such as an amulet, may broadcast the signal; etc.). The signal may be evaluated to identify the privacy preference for the entity. For example, the signal may be received and/or decoded by the multimedia device comprising the multimedia content. The decoded signal may specify the privacy preference for the entity (e.g., a no facial recognition privacy preference). In this way, the multimedia device may directly identify the privacy preference based upon the signal specifying the privacy preference. In another example of identifying a privacy preference, a signal broadcast from a device associated with the entity may be identified. The signal may be evaluated to identify an entity identifier for the entity. For example, the multimedia device may receive and/or decode the signal to obtain the entity identifier. The entity identifier may correspond to a unique identifier used by a privacy preference provider component, such as a cloud service accessible to the multimedia device, to associate the entity with an entity profile comprising privacy preferences for the entity. In this way, the privacy preference provider component may use the entity identifier to identify the privacy preference for the entity (e.g., a publishing privacy preference that restrict publishing of photos of the entity for particular websites, social networks, email, messaging, etc.).

In another example of identifying a privacy preference, a recognition technique, such as facial recognition and/or voice recognition, may be performed on the multimedia content to identify an entity identifier for the entity. For example, facial recognition may identify a user John as being depicted within a photo. In this way, the privacy preference provider component may use the entity identifier to identify the privacy preference for the entity (e.g., a no tagging privacy preference for a particular social network specified by John). In another example of identifying a privacy preference, gesture recognition may be performed on the multimedia content to identify a gesture associated with the entity. For example, a photo may depict a user crossing their arms in a particular manner, which may be identified as a no photography gesture. Such a no photography gesture and/or other gestures may be universally identifiable gestures that may be recognizable to society as activating privacy protection technology. The gesture may be evaluated to identify the privacy preference for the entity (e.g., a no photography privacy preference). In another example of identifying a privacy preference, object recognition may be performed on the multimedia content to identify a privacy object associated with the entity (e.g., a visual amulet, a sticker, a tee-shirt, a bracelet, a military label, etc.). For example, a prototype car may comprise a label, bar code, QR code, etc. as the privacy object. The privacy object may be evaluated to identify the privacy preference for the entity (e.g., the multimedia device may match the label to a privacy object database to identify a no logging privacy preference specifying that activity and locational data for the prototype car cannot be logged, a social media privacy preference specifying that photos of the prototype car cannot be uploaded to a particular social network, and/or other privacy preferences). In this way, a wide variety of techniques may be performed to identify one or more privacy preferences for the entity associated with the multimedia content. It is to be appreciated that the instant application, including the scope of the appended claims, is not intended to be limited by the examples provided herein. Rather, more than merely the examples provided are contemplated herein.

At 208, the privacy preference may be applied to the multimedia content. In an example, a blur effect may be applied to a depiction of the entity within the multimedia content based upon a no photography privacy preference. In another example, audio of the entity within video multimedia content may be muffled, filtered, etc. based upon a no audio privacy preference. In another example, a tag restriction may be applied to a depiction of the entity within the multimedia content based upon a no tagging privacy preference. In another example, facial recognition on a depiction of the entity within the multimedia content may be restricted based upon a facial recognition privacy preference (e.g., the entity may be wearing a privacy object, such as an amulet, design, logo, etc., specifying the no facial recognition privacy preference). In another example, a log activity restriction may be applied to the multimedia content with respect to the entity based upon a no logging privacy preference (e.g., a social network and/or other service may be blocked from logging information about a user as having eaten at a restaurant as depicted by the multimedia content). In another example, a profiling activity restriction may be applied to the multimedia content with respect to the entity based upon a no profiling privacy preference (e.g., a social network and/or other service may be blocked from building and/or updating a profile for a user depicted within the multimedia content). In this way, privacy preferences for entities may be applied to multimedia content. It will be appreciated that the instant application, including the scope of the appended claims, is not intended to be limited to or by the examples provided herein. For example, an object can have any shape, form, configuration, etc. (e.g., universally known, agreed upon, etc.) to indicate one or more privacy preferences. Moreover, it is contemplated that a privacy preference may be applied based upon a current law, regulation, mandate, etc. for a particular location, such as a state within which the multimedia content was created. At 210, the method ends.

FIG. 3 illustrates an example of a system 300 for providing privacy preferences for an entity. The system 300 comprises a privacy preference provider component 314. In an example, the privacy preference provider component 314 may be implemented as a service (e.g., hosted by a server) remotely accessible to a multimedia device 306 of a user 304. In another example, the privacy preference provider component 314 may be implemented on the multimedia device 306. The user 304 may capture multimedia content, such as a photo, of an entity 302 using the multimedia device 306. The multimedia device 306 may receive an indication 310 from a privacy signaling component 308, such as a mobile device, associated with the entity 302. In an example, the indication 310 may comprise a signal broadcast from the privacy signaling component 308. The indication 310 may specify an entity identifier for the entity 302, which may be identified by the multimedia device 306 based upon decoding the signal (e.g., where the signal may impact how the multimedia device 306 saves, shares, processes, etc. the multimedia content, such as described with respect to FIG. 2).

The privacy preference provider component 314 may receive a query 312 from the multimedia device 306. The query 312 may specify the entity identifier. The privacy preference provider component 314 may be configured to query an entity profile repository 318, comprising one or more entity profiles, to identify 316 an entity profile matching the entity identifier. The entity profile may comprise one or more privacy preferences, such as a privacy preference 320, specified by the entity 302 (e.g., through a configuration interface and/or otherwise, such as discussed with respect to FIG. 1). The privacy preference provider component 314 may provide the privacy preference 320 to the multimedia device 306. In this way, the multimedia device 306 may apply the privacy preference 320 to the multimedia content (e.g., blur the entity 302 depicted within the photo).

FIG. 4 illustrates an example of a system 400 for providing privacy preferences for an entity. The system 400 comprises a privacy preference provider component 414. In an example, the privacy preference provider component 414 may be implemented as a cloud service accessible to a multimedia device 406 of a user 404. In another example, the privacy preference provider component 414 may be implemented on the multimedia device 406. The user 404 may capture multimedia content, such as a video, of an entity 402 using the multimedia device 406. In an example, the multimedia device 406 may perform voice recognition and/or audio recognition on the video to identify an entity identifier for the entity 402 (e.g., the multimedia device 406 may access and/or utilize a recognition service to identify the entity identifier).

The privacy preference provider component 414 may receive a query 408 from the multimedia device 406. The query 408 may specify the entity identifier. The privacy preference provider component 414 may be configured to query an entity profile repository 418, comprising one or more entity profiles, to identify 416 an entity profile matching the entity identifier. The entity profile may comprise one or more privacy preferences, such as a privacy preference 420, specified by the entity 402 (e.g., through a configuration interface and/or otherwise, such as discussed with respect to FIG. 1). The privacy preference provider component 414 may provide the privacy preference 420 to the multimedia device 406. In this way, the multimedia device 406 may apply the privacy preference 420 to the multimedia content (e.g., a no tagging privacy preference may be applied to the video).

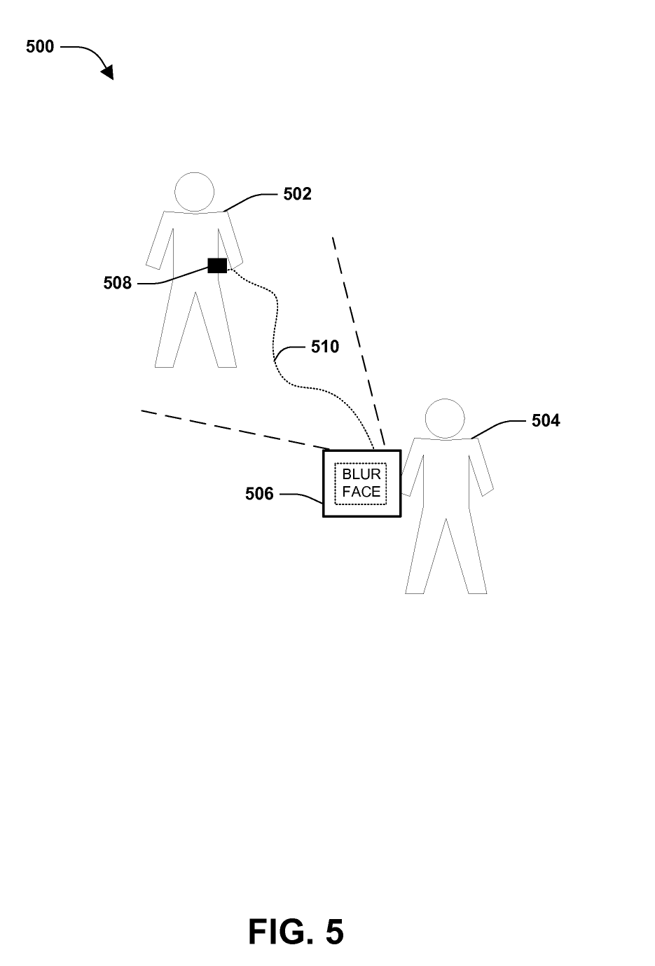

FIG. 5 illustrates an example of a system 500 for providing a privacy preference signal for an entity. The system 500 comprises a privacy signaling component 508 associated with an entity 502 (e.g., an app of a mobile device). The privacy signaling component 508 may be configured to provide an indication 510 to a multimedia device 506 of a user 504 that is capturing multimedia content associated with the entity 502. For example, the privacy signaling component 508 may provide the indication 510 comprising a signal broadcast to the multimedia device 506. The indication 510 may specify a privacy preference instruction for the entity 502, such as a no photography privacy preference specifying that imagery of the entity 502 is to be blurred. In this way, the multimedia device 506 may honor the privacy preference instruction by blurring a depiction of the entity 502 within the multimedia content. In an example, the multimedia device 506 may honor the privacy preference instruction utilizing client side processing (e.g., without accessing remote services, and thus the multimedia device 506 may support privacy preferences while “offline” such as when connectivity (e.g., to a server) is unavailable).

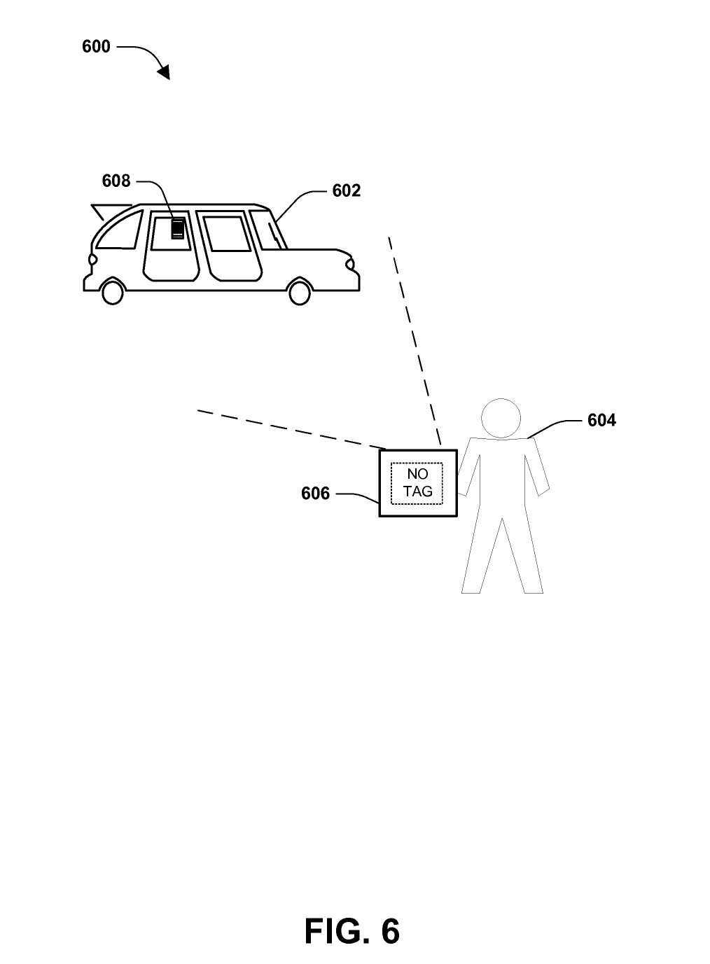

FIG. 6 illustrates an example of a system 600 for providing a privacy preference signal for an entity. The system 600 comprises a privacy signaling component 608 associated with an entity 602. The privacy signaling component 608 may comprise a privacy object (e.g., a sticker, RFID tag, etc.) visually and/or otherwise recognizable to a multimedia device 606. The privacy object may be associated with a privacy preference instruction (e.g., a no tagging privacy preference). In an example, the multimedia device 606 captures multimedia content, such as a video, depicting the entity 602. The multimedia device 606 may evaluate the privacy object, such as the sticker, of the privacy signaling component 608 to identify the no tagging privacy preference (e.g., the multimedia device 606 may query (e.g., remotely and/or locally) a privacy object repository using the sticker and/or information/data obtained therefrom to identify a corresponding privacy preference instruction). In this way, the multimedia device 606 may honor the privacy preference instruction by implementing the no tagging privacy preference for the video.

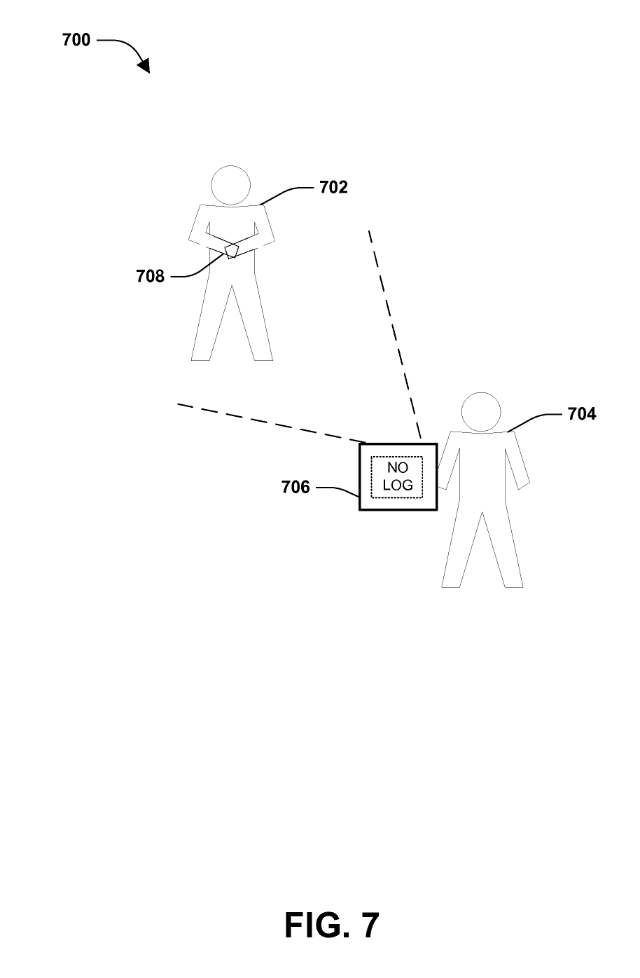

FIG. 7 illustrates an example of a system 700 for applying a privacy preference for an entity. The system 700 comprises a privacy implementation component 706 hosted on a multimedia device of a user 704. In an example, the user 704 may capture multimedia content of an entity 702 using the multimedia device. The privacy implementation component 706 may perform gesture recognition on the multimedia content to identify a gesture 708, for example a universally agreed upon gesture, such as the entity 702 crossing arms. The privacy implementation component 706 may evaluate the gesture 708 to identify a no logging privacy preference associated with the gesture (e.g., the privacy implementation component 706 may query (e.g., remotely and/or locally) a gesture repository and/or a privacy preference provider service to identify the no logging privacy preference). In this way, the multimedia device 706 may honor the no logging privacy preference for the multimedia content.

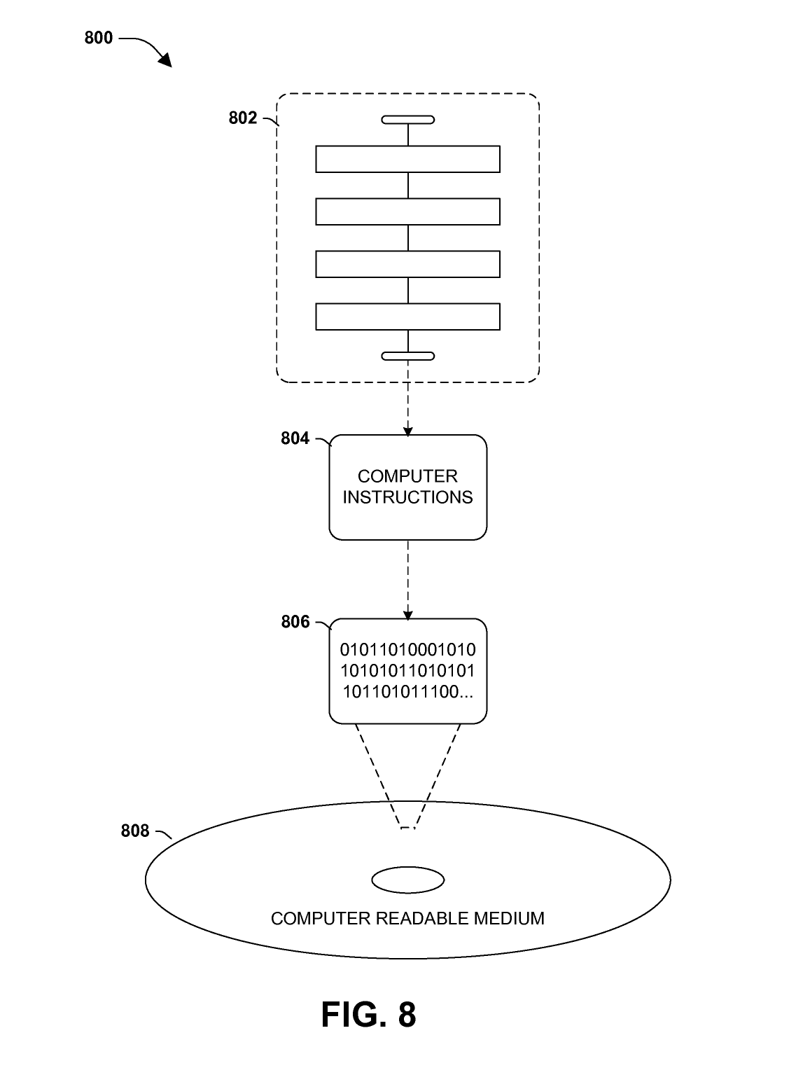

Still another embodiment involves a computer-readable medium comprising processor-executable instructions configured to implement one or more of the techniques presented herein. An example embodiment of a computer-readable medium or a computer-readable device is illustrated in FIG. 8, wherein the implementation 800 comprises a computer-readable medium 808, such as a CD-R, DVD-R, flash drive, a platter of a hard disk drive, etc., on which is encoded computer-readable data 806. This computer-readable data 806, such as binary data comprising at least one of a zero or a one, in turn comprises a set of computer instructions 804 configured to operate according to one or more of the principles set forth herein. In some embodiments, the processor-executable computer instructions 804 are configured to perform a method 802, such as at least some of the exemplary method 200 of FIG. 2, for example. In some embodiments, the processor-executable instructions 804 are configured to implement a system, such as at least some of the exemplary system 100 of FIG. 1, at least some of the exemplary system 300 of FIG. 3, at least some of the exemplary system 400 of FIG. 4, at least some of the exemplary system 500 of FIG. 5, at least some of the exemplary system 600 of FIG. 6, and/or at least some of the exemplary system 700 of FIG. 7, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

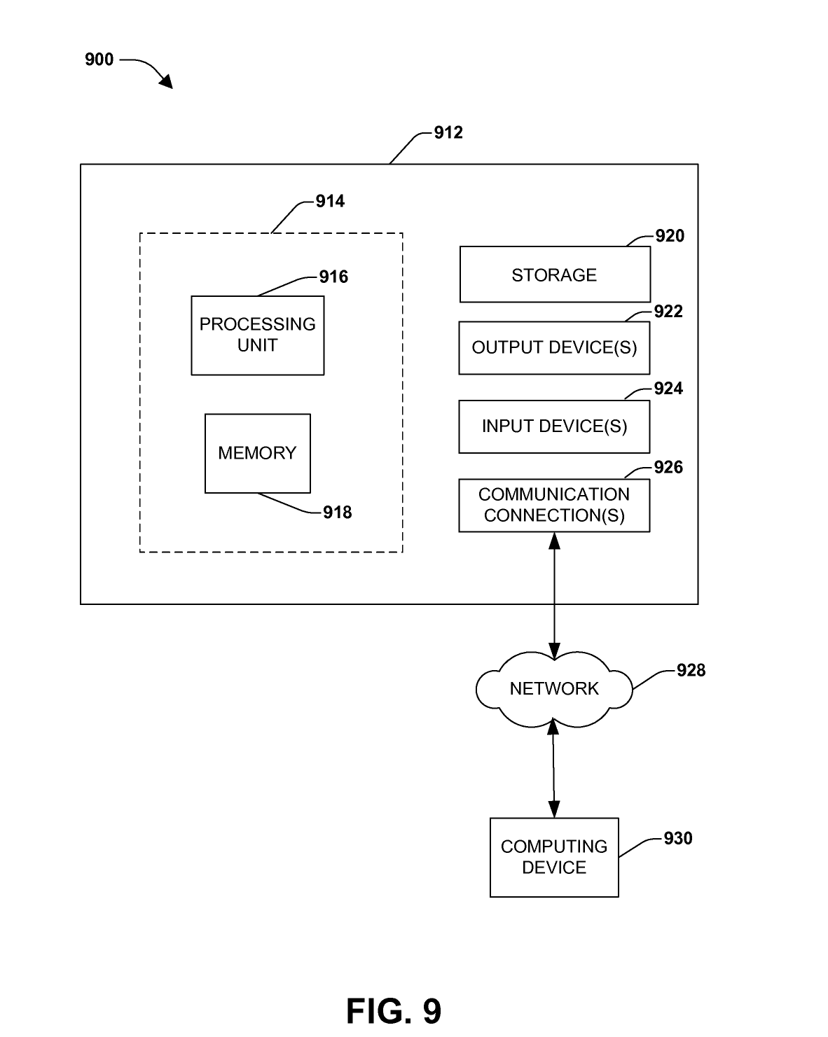

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 900 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Computer storage media does not, however, include propagated signals. Rather, computer storage media excludes propagated signals. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for applying privacy preferences for an entity, comprising:
capturing multimedia content associated with an entity;
identifying a privacy preference for the entity; and
applying the privacy preference to the multimedia content.

2. The method of claim 1, the identifying a privacy preference comprising:
identifying a signal broadcast from a device associated with the entity; and
evaluating the signal to identify the privacy preference for the entity.

3. The method of claim 1, the identifying a privacy preference comprising:
identifying a signal broadcast from a device associated with the entity;
evaluating the signal to identify an entity identifier for the entity; and
querying a privacy preference provider component using the entity identifier to identify the privacy preference for the entity.

4. The method of claim 1, the identifying a privacy preference comprising:
performing at least one of facial recognition or voice recognition on the multimedia content to identify an entity identifier for the entity; and
querying a privacy preference provider component using the entity identifier to identify the privacy preference for the entity.

5. The method of claim 1, the identifying a privacy preference comprising:
performing gesture recognition on the multimedia content to identify a gesture associated with the entity; and
evaluating the gesture to identify the privacy preference for the entity.

6. The method of claim 1, the identifying a privacy preference comprising:
performing object recognition on the multimedia content to identify a privacy object associated with the entity; and
evaluating the privacy object to identify the privacy preference for the entity.

7. The method of claim 1, the applying the privacy preference comprising:
applying a blur effect to a depiction of the entity within the multimedia content based upon a no photography privacy preference.

8. The method of claim 1, the applying the privacy preference comprising:
applying a tag restriction to a depiction of the entity within the multimedia content based upon a no tagging privacy preference.

9. The method of claim 1, the applying the privacy preference comprising:
restricting facial recognition on a depiction of the entity within the multimedia content based upon a facial recognition privacy preference.

10. The method of claim 1, the applying the privacy preference comprising:
applying a log activity restriction to the multimedia content with respect to the entity based upon a no logging privacy preference.

11. The method of claim 1, the applying the privacy preference comprising:
applying a profiling activity restriction to the multimedia content with respect to the entity based upon a no profiling privacy preference.

12. A system for providing privacy preferences for an entity, comprising:
a privacy signaling component configured to:
provide an indication to a multimedia device that is capturing multimedia content associated with an entity, the indication specifying at least one of a privacy preference instruction or an entity identifier for the entity, the entity identifier associated with a privacy preference for the entity.

13. The system of claim 12, the indication comprising a signal broadcast from the privacy signaling component to the multimedia device.

14. The system of claim 12, the privacy signaling component comprising a privacy object visually recognizable to the multimedia device, the privacy object associated with the privacy preference instruction.

15. A system for providing privacy preferences for entities, comprising:
a privacy preference provider component configured to:
receive a query from a multimedia device, the query specifying an entity identifier of an entity associated with multimedia content captured by the multimedia device;
identify an entity profile matching the entity identifier; and
provide a privacy preference from the entity profile to the multimedia device.

16. The system of claim 15, the privacy preference provider component hosted as a privacy preference service remotely accessible to the multimedia device.

17. The system of claim 15, comprising:
an entity profile management component configured to:
responsive to receiving a new registration request from a new entity, expose an entity profile configuration interface to the new entity;
receive new entity privacy preference information through the entity profile configuration interface; and
generate a new entity profile associated with a new entity identifier for the new entity based upon the new entity privacy preference information.

18. The system of claim 17, the entity profile management component configured to:
receive a new entity privacy preference update; and
update the new entity profile based upon the new entity privacy preference update.

19. The system of claim 17, the privacy preference provider component configured to:
receive a second query from a second multimedia device, the second query specifying the new entity identifier of the new entity associated with second multimedia content captured by the second multimedia device;
identify the new entity profile matching the new entity identifier; and
provide a second privacy preference from the new entity profile to the second multimedia device.

20. The system of claim 15, the privacy preference comprising at least one of:
a no photography privacy preference;
a no tagging privacy preference;
a facial recognition privacy preference;
a no logging privacy preference;
a no profiling privacy preference;
a social media privacy preference;
a no voice recognition privacy preference;
a location tagging privacy preference; or
a publishing privacy preference.
